(19) United States
(12) Patent Application Publication
(10) Pub. No.: US 2026/0323070 A1
(43) Pub. Date: Oct. 15, 2026

(54) HASH TABLE CONSTRUCTION METHOD, VIDEO CODING METHOD, ENCODER, ELECTRONIC DEVICE, AND MEDIUM

(71) Applicant: CLOUD INTELLIGENCE ASSETS HOLDING (SINGAPORE) PRIVATE LIMITED, Singapore (SG)

(72) Inventor: Yi ZHANG, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/484,345

(22) PCT Filed: Apr. 11, 2024
(86) PCT No.: PCT/CN2024/087328

§ 371 Date: Nov. 13, 2025

(30) Foreign Application Priority Data
May 15, 2023 (CN) 202310556020.6

(51) Int. Cl. H04N 19/513; G06F 16/22; H04N 19/176

(52) U.S. Cl. CPC H04N 19/513; G06F 16/2255; H04N 19/176

(57) ABSTRACT

A hash table construction method, a video coding method, an encoder, an electronic device and a medium are provided. The hash table construction method includes: obtaining a target video frame, and obtaining motion vector information included in a preset selected area of the target video frame; in response to the motion vector information being greater than a preset motion vector threshold, obtaining pixel block information of one or more target pixel blocks in the preset selected area of the target video frame; and constructing a hash table of the preset selected area of the target video frame based on the pixel block information.

### CROSS REFERENCE TO RELATED APPLICATIONS

This disclosure is a National Stage of International Application PCT/CN2024/087328, filed on Apr. 11, 2024, which claims priority to Chinese Patent Application No. 202310556020.6, filed with the China National Intellectual Property Administration on May 15, 2023, and entitled “HASH TABLE CONSTRUCTION METHOD, VIDEO CODING METHOD, CODER, ELECTRONIC DEVICE, AND MEDIUM”, the mentioned applications are incorporated herein by reference.

### TECHNICAL FIELD

This disclosure relates to the field of video processing technologies, and in particular, to a hash table construction method, a video coding method, a corresponding encoder, a corresponding electronic device, and a corresponding computer-readable storage medium.

### BACKGROUND

With the rise of video services such as short videos, video conferencing, live streaming, and network video on demand, videos gradually replace some conventional manners of pictures and texts, and become one of the main manners in aspects such as entertainment, information obtaining, working, and learning in people's life. From a perspective of video content, a Screen Content Coding (SSC) video has features of less noise, weak continuity of texture in space domain, and a larger motion range in time domain, compared with a common natural video.

HashMe is one of high efficiency coding tools for SCC videos. During coding, an encoder calculates features of a current to-be-coded block when performing motion searching. An implementation thereof usually depends on indexing a hash table of a reference frame of the current to-be-coded block to find a coded block, as a reference block of the current to-be-coded block, with a same feature value as the feature value of the current to-be-coded block. However, the manner of constructing a hash table by extracting features of a coded block during coding easily increases coding complexity of HashMe.

### SUMMARY

In view of the above problems, embodiments of this disclosure are proposed to provide a hash table construction method, a video coding method, a corresponding encoder, a corresponding electronic device, and a corresponding computer-readable storage medium, to overcome or at least partially resolve the above problems.

An embodiment of this disclosure discloses a hash table construction method. The method includes:
obtaining a target video frame, and obtaining motion vector information included in a preset selected area of the target video frame;
in response to the motion vector information being greater than a preset motion vector threshold, obtaining pixel block information of one or more target pixel blocks in the preset selected area of the target video frame; and
constructing a hash table of the preset selected area of the target video frame based on the pixel block information.

Optionally, the in response to the motion vector information being greater than a preset motion vector threshold, obtaining pixel block information of one or more target pixel blocks in the preset selected area of the target video frame includes:
obtaining a pixel window, where the pixel window is determined based on a preset pixel block size; and
in response to the motion vector information being greater than the preset motion vector threshold, capturing, by using the pixel window, the pixel block information of the one or more target pixel blocks in the preset selected area of the target video frame.

Optionally, a plurality of pieces of motion vector information are included in the preset selected area of the target video frame; and the in response to the motion vector information being greater than the preset motion vector threshold, capturing, by using the pixel window, the pixel block information of the one or more target pixel blocks in the preset selected area of the target video frame includes:
in response to at least one piece of motion vector information being greater than the preset motion vector threshold, capturing, by using the pixel window, the pixel block information of the one or more target pixel blocks in the preset selected area of the target video frame.

Optionally, the motion vector information includes first dimension motion vector information and second dimension motion vector information, and the preset motion vector threshold includes a preset first dimension motion vector threshold and a preset second dimension motion vector threshold.

The in response to at least one piece of motion vector information being greater than the preset motion vector threshold, capturing, by using the pixel window, the pixel block information of the one or more target pixel blocks in the preset selected area of the target video frame includes:
in response to the first dimension motion vector information of at least one piece of motion vector information being greater than the preset first dimension motion vector threshold, or the second dimension motion vector information of at least one piece of motion vector information being greater than the preset second dimension motion vector threshold, capturing, by using the pixel window, the pixel block information of the one or more target pixel blocks in the preset selected area of the target video frame.

Optionally, the capturing, by using the pixel window, the pixel block information of the one or more target pixel blocks in the preset selected area of the target video frame includes:
determining a pixel block in the pixel window of the target video frame as the target pixel block, and capturing the pixel block information of the target pixel block; and
continuously sliding the pixel window within a range of the preset selected area of the target video frame according to a preset horizontal step and a preset vertical step, continuously determining a pixel block in the pixel window of the target video frame as the target pixel block, and capturing the pixel block information of the target pixel block, until pixel block information of all target pixel blocks included in the preset selected area of the target video frame are captured.

Optionally, the method further includes:
continuously determining a next preset selected area in the target video frame according to a range size of the preset selected area, obtaining motion vector information included in the next preset selected area of the target video frame, obtaining pixel block information of one or more target pixel blocks in the next preset selected area in response to newly obtained motion vector information being greater than the preset motion vector threshold, and constructing a hash table of the next preset selected area based on newly obtained pixel block information until determined preset selected areas cover the target video frame.

Optionally, the target pixel block includes at least one target pixel block, and the pixel block information includes a coding feature value and pixel block coordinate information; and the constructing a hash table of the preset selected area of the target video frame based on the pixel block information includes:
extracting the coding feature value of the at least one target pixel block, and obtaining the pixel block coordinate information of the at least one target pixel block; and
constructing the hash table of the preset selected area of the target video frame by using the coding feature value of each target pixel block as an index and the pixel block coordinate information of each target pixel block as content, where the hash table of at least one preset selected area of the target video frame forms a hash table of the target video frame.

Optionally, the method further includes:
in response to the target video frame being a scene switching frame reference frame, obtaining a pixel window, capturing, by using the pixel window, pixel block information of one or more pixel blocks included in the scene switching frame reference frame, and constructing a hash table of the scene switching frame reference frame based on the pixel block information of the one or more pixel blocks included in the scene switching frame reference frame.

Optionally, the method further includes:
obtaining a to-be-coded video frame, and coding the to-be-coded video frame by using the hash table of the preset selected area of the target video frame, where the to-be-coded video frame is a video frame referring to the target video frame; and/or
coding the to-be-coded video frame by using the hash table of the preset selected area of the target video frame and the hash table of the scene switching frame reference frame.

An embodiment of this disclosure further discloses a video coding method. The method includes:
obtaining a to-be-coded video frame and a hash table of a target video frame of a video file in response to an input instruction of the video file, where the to-be-coded video frame is a video frame referring to the target video frame, the hash table of the target video frame includes a hash table of a preset selected area of the target video frame, and the hash table of the preset selected area is constructed based on pixel block information of one or more target pixel blocks in the preset selected area in response to motion vector information of the target video frame being greater than a preset motion vector threshold; and
coding the to-be-coded video frame by using the hash table of the target video frame.

Optionally, the hash table of the target video frame further includes a hash table of a scene switching frame reference frame, and the hash table of the scene switching frame reference frame is constructed based on pixel block information of one or more pixel blocks included in the scene switching frame reference frame.

An embodiment of this disclosure further discloses a hash table construction apparatus. The apparatus includes:
a motion vector information obtaining module, configured to: obtain a target video frame, and obtain motion vector information included in a preset selected area of the target video frame;
a pixel block information obtaining module, configured to: in response to the motion vector information being greater than a preset motion vector threshold, obtain pixel block information of one or more target pixel blocks in the preset selected area of the target video frame; and
a first hash table construction module, configured to construct a hash table of the preset selected area of the target video frame based on the pixel block information.

An embodiment of this disclosure further discloses a video coding apparatus. The apparatus includes:
a hash table obtaining module, configured to obtain a to-be-coded video frame and a hash table of a target video frame of a video file in response to an input instruction of the video file, where the to-be-coded video frame is a video frame referring to the target video frame, the hash table of the target video frame includes a hash table of a preset selected area of the target video frame, and the hash table of the preset selected area is constructed based on pixel block information of one or more target pixel blocks in the preset selected area in response to motion vector information of the target video frame being greater than a preset motion vector threshold; and
a video coding module, configured to code the to-be-coded video frame by using the hash table of the target video frame.

An embodiment of this disclosure further discloses an encoder, the encoder includes a computer program executed in the encoder, and the computer program, when executed by the encoder, implements any one of the hash table construction methods or any one of the video coding methods.

An embodiment of this disclosure further discloses an electronic device, including: a processor, a memory, and a computer program stored on the memory and executable on the processor, where the computer program, when executed by the processor, implements any one of the hash table construction methods or any one of the video coding methods.

An embodiment of this disclosure further discloses a computer-readable storage medium, where the computer-readable storage medium stores a computer program, and the computer program, when executed by a processor, implements any one of the hash table construction methods or any one of the video coding methods.

The embodiments of this disclosure have the following advantages:

In this embodiment of this disclosure, motion vector information included in a preset selected area of a target video frame is obtained, then pixel block information of one or more target pixel blocks in the preset selected area is obtained when the obtained motion vector information is greater than a preset motion vector threshold, and a hash table of the preset selected area is constructed. The motion vector information is introduced into a process of constructing the hash table, and the hash table is constructed for a preset selected area of a target video frame when the motion vector information is greater than a preset motion vector threshold, thereby implementing selective construction of the hash table in divided areas, shortening construction time of the hash table, and further reducing time complexity and coding complexity.

### BRIEF DESCRIPTION OF DRAWINGS

FIG. 1 is a flowchart illustrating steps of a hash table construction method according to an embodiment of this disclosure.

FIG. 2 is a flowchart illustrating steps of another hash table construction method according to an embodiment of this disclosure.

FIG. 3 is a flowchart illustrating steps of a video coding method according to an embodiment of this disclosure.

FIG. 4 is a schematic diagram of a framework of a video encoder according to an embodiment of this disclosure.

FIG. 5 is a schematic diagram of an application scenario of hash table construction and video coding according to an embodiment of this disclosure.

FIG. 6 is a structural block diagram of a hash table construction apparatus according to an embodiment of this disclosure.

FIG. 7 is a structural block diagram of a video coding apparatus according to an embodiment of this disclosure.

### DETAILED DESCRIPTION

To make the foregoing objectives, features, and advantages of this disclosure clearer and easier to understand, the following further describes this disclosure in detail with reference to the accompanying drawings and specific implementations.

For ease of understanding this disclosure by persons skilled in the art, the following explains terms or nouns involved in the embodiments of this disclosure:
SCC: Screen Content Coding, which refers to compression coding and algorithm redesign specifically aimed at screen content, based on inherent features of the screen content and a feature difference from natural scene content.
H.265/HEVC: Play High Efficiency Video Coding, which is an international video coding standard.
HashMe: HashMe is a coding technology of HEVC, and is one of high efficiency coding tools for SCC videos.
IBC: Intra Block Copy, which is a coding technology of HEVC, where a conventional video coding technology whose principle is very similar to that of the IBC is Motion Compensation (MC) during inter-frame coding, and both IBC and MC are technologies for obtaining a predicted pixel value based on block matching.
Palette: Palette is a coding technology of HEVC, and is mainly used for compressing and coding screen content.
Transform Skip: Transform skip mode, which is a technology introduced in the HEVC, and which has a definite effect on a video sequence whose scene changes slowly.
RDCost: Rate Distortion cost, which refers to data rate distortion costs, mainly comprehensively considering costs of impact of a coding tool on a bit rate and quality.
CU: Coding Unit, which is a coding unit.
QP: Quantization Parameter, which indicates an exportable quantization step.
Motion searching: Mainly a process of finding, in a reference frame, a matching block having a small difference from a current block.
Motion estimation: A technology of extracting motion information from a video sequence.
MV: Motion Vector, which refers to a vector connecting a current block and a matching block, and is used for representing a motion direction of an object in a video.
BDrate: Bjøntegaard-Delta rate, which is used for evaluating rate distortion performance of different video encoders, and which is a measurement indicator of an effect of a video coding algorithm in the embodiments of this disclosure, indicating a change status of a bit rate on a premise of same reconstruction quality. Generally, a negative number may be used for indicating that a code rate is reduced and coding efficiency is improved.
Skip: A skip mode, which is a special merge mode, and has a function of reducing a bit rate.
Merge: A merge mode, where vector information of a current block is predicted mainly by using vector information of adjacent blocks in time domain and space domain.
Amvp: Advanced motion vector prediction, which is a technology in which a space domain candidate list and a time domain candidate list are respectively established mainly by using correlation between motion vectors in space and time, and then an MVP is selected from the candidate lists.
Intra: Intra mode, which is a technology mainly based on: partitioning a macroblock into sub-blocks having a size corresponding to the mode, and performing prediction on each sub-block based on pixels of currently coded adjacent blocks of the sub-block.

With the rise of video services such as short videos, video conferencing, live streaming, and network video on demand, videos gradually replace some conventional manners of pictures and texts, and become one of the main manners in aspects such as entertainment, information obtaining, working, and learning in people's life, and video services will continue to develop rapidly in the future in orders of magnitude and video forms.

Compared with conventional pictures and texts, videos have more intuitive and interesting content expression traits. However, with the high-speed development of the video services, data volumes generated by video transmission and storage cannot be ignored, and have higher requirements on transmission bandwidth and storage space. Video coding undertakes the critical task of video compression, and as a component in the video transmission and storage pipeline, reduces a video file size as much as possible while maintaining perceptually acceptable visual quality, thereby achieving objectives of reducing bandwidth costs of an enterprise and providing clearer and smoother visual experience for users. The video coding process is completed by a video encoder.

From a perspective of video content, video services may be classified into SSC videos and common natural videos. Compared with the common natural video, the SSC video has features of less noise, weak continuity of texture in space domain, and a larger motion range in time domain. Consequently, policies of encoders for coding the SCC video and the natural video are greatly different. Some coding technologies are mainly for the SCC video, for example, including IBC, Palette, Transform Skip, and HashMe. The rise of video conferencing and video teaching causes an increasingly large demand for the SCC video, and a demand for improving compression efficiency of the SCC video also naturally increases.

In related coding technologies for the SCC video, using HashMe as an example, HashMe is one of high efficiency coding tools for the SCC video, and is mainly represented as that: an encoder extracts a feature of a coded block during coding, then uses the feature as a subscript index of a hash table, and uses coordinates of the coded block as content pointed to by the index, so that one index may point to multiple content, thereby constructing the hash table. During motion searching, the encoder calculates a feature of a current block, finds a coded block having a feature value that is the same as a feature value of the current block mainly based on an index of a hash table of a reference frame of the current block, and uses the coded block as a reference block of the current block. That is, a manner of coding the SCC video by using HashMe relies on construction of the hash table.

However, in a related technology of constructing the hash table, HashMe in HM reference software uses a manner of constructing the hash table based on a pixel-by-pixel granularity of an entire frame. In this hash table construction manner, the hash table is constructed in a dimension of each frame, and construction of the hash table has a large computing power consumption requirement. Therefore, although HashMe can improve compression efficiency, it still causes high time complexity and high coding complexity, and is not applicable to an actual application.

In this embodiment of the present disclosure, the hash table is selectively constructed based on estimation of a video motion. Specifically, by introducing motion vector information, status determining of a preset selected area in a target video frame is performed based on a preset motion vector threshold, to selectively construct the hash table for a preset selected area in a large motion state, and a frame-level pixel-by-pixel table construction manner based on an entire frame in HashMe is replaced with an area-level table construction manner for an area in the large motion state, so that the complexity of HashMe is reduced, and compression efficiency gains brought by HashMe are not affected. In addition, when a target video frame hits scene switching, that is, the target video frame is a scene switching frame, frame-level table construction may be additionally performed on the target video frame. By combining the frame-level pixel-by-pixel table construction manner based on an entire frame and an area-level table construction manner for an area in a large motion state, utilization of HashMe is improved as much as possible, and complexity of HashMe is reduced as much as possible while a performance gain is ensured.

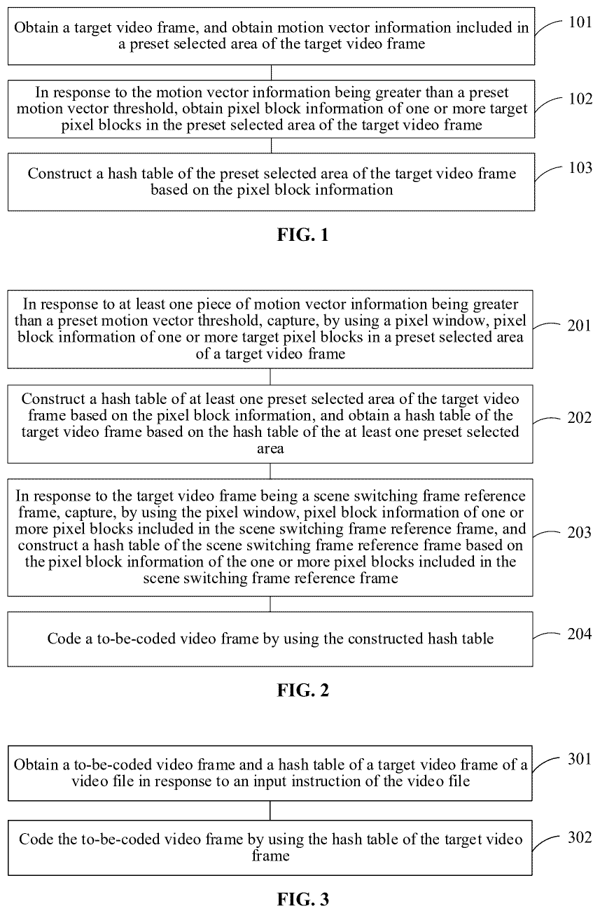

FIG. 1 is a flowchart illustrating steps of a hash table construction method according to an embodiment of this disclosure. The method may specifically include the following steps.

Step 101: Obtain a target video frame, and obtain motion vector information included in a preset selected area of the target video frame.

The target video frame is a coded video frame, and may include several coded pixel blocks (coded blocks for short). Features of the coded blocks may be used for determining a reference block of a to-be-coded block included in a to-be-coded frame, so that motion estimation is performed on the to-be-coded block based on the reference block in the coding process, thereby facilitating prediction and coding on the to-be-coded block.

For an SCC video, a texture area in which an object quickly moves exists in an area in a large motion state. It is difficult to match an ideal reference block by using a conventional coding technology, for example, conventional modes such as Skip, Merge, Amvp, and Intra. In this case, the reference block may be searched for by indexing the reference block based on a hash table. In other words, determining of the reference block depends on a hash table constructed for coded blocks. However, usually, most areas of a video frame are not continuously in the large motion state. Especially for an SCC sequence, a large motion usually occurs in a local area and lasts for very short time. In this case, to ensure that the complexity of HashMe is reduced without affecting the compression efficiency gain brought by HashMe, with reference to features of the local area in the large motion state in the SCC sequence, a manner of constructing a hash table for the target video frame based on an area may be performed.

The manner of constructing the hash table based on an area may be represented as selectively constructing the hash table. Specifically, the hash table may be selectively constructed based on video motion estimation. Specifically, selectively constructing the hash table may be represented as follows: motion vector information is introduced, status of a preset selected area in the target video frame is determined based on a preset motion vector threshold, a hash table is selectively constructed for the preset selected area in a large motion state.

In an embodiment of this disclosure, hash table construction for the target video frame based on an area may be started by selecting an area to analyze and construct the hash table. The selected area may be a preset selected area. A range size or a dimension of the preset selected area is generally less than a set size threshold of a coding unit, that is, may be determined based on a size of a coding unit used by an encoder during coding. For example, in an encoder using the H.265/HEVC coding standard, the range size or the dimension of the preset selected area is generally less than 64 px×64 px.

For introduction of the motion vector information, during actual application, motion vector information included in the preset selected area of the target video frame may be obtained, to determine a motion state of a current local area based on the motion vector information of the preset selected area. The preset selected area may include a plurality of pixel blocks, and the preset selected area may include a plurality of pieces of motion vector information, to be specific, a single preset selected area may include a plurality of pieces of motion vector information corresponding to a plurality of pixel blocks. A motion vector of the preset selected area may refer to a vector connecting a current block and a matching block. The current block may refer to the current pixel block in the current preset selected area, and the matching block is a pixel block that is used for reference and that is found through motion searching on a reference frame when the current pixel block is coded. The motion vector information may be mainly used for measuring a motion direction and a motion distance of object content related to the current pixel block. In other words, the motion vector information may include a motion distance in a direction of object content related to the current pixel block.

It should be noted that, it is difficult for a range size or a dimension of a single preset selected area to cover the entire target video frame. In this embodiment of this disclosure, a position of a next preset selected area in the target video frame may be determined based on the range size of the preset selected area, or the current preset selected area is moved on the target video frame, and a motion state of a local area corresponding to the preset selected area continues to be determined until determining of a motion state of an entire area included in the target video frame is completed.

Step 102: In response to the motion vector information being greater than a preset motion vector threshold, obtain pixel block information of one or more target pixel blocks in the preset selected area of the target video frame.

After the motion state of the current local area is determined based on the motion vector information of the preset selected area, to facilitate construction of the hash table for an area in the large motion state, pixel block information of the one or more target pixel blocks in the preset selected area of the target video frame may be obtained.

The motion state of the current local area may be determined mainly based on the motion vector information and the preset motion vector threshold. Specifically, when the motion vector information is greater than the preset motion vector threshold, it may be determined that the motion state of the current local area (that is, the current preset selected area) is the large motion state, to selectively construct the hash table of the preset selected area in the large motion state based on obtaining of the pixel block information in this case.

It should be noted that, the preset threshold may be a threshold that is preset based on an experimental value or an empirical value, or may be a threshold that is adaptively derived from historical coding information. The derived threshold can improve algorithm robustness. A manner of determining the preset threshold is not limited in this embodiment of this disclosure. In addition, the motion vector information may be generated in an original procedure of performing video coding on the target video frame. In this case, the motion vector information included in the preset selected area may be obtained based on a position and a range size of the preset selected area in the target video frame. The original procedure of performing video coding on the target video frame is not limited in this embodiment of this disclosure.

The large motion state may be a state in which an object moves rapidly, and may be specifically determined based on the motion vector information. The motion vector information may be used for representing a current motion vector direction and a motion distance. Generally, when the motion distance in the current motion vector direction is greater than a set motion distance threshold in the current motion vector direction, it is considered that the situation satisfies a condition of being in the large motion state.

In an actual application, the pixel block information of the target pixel block may be captured based on the pixel window. After it is determined that the motion state of the current local area is the large motion state, corresponding pixel block information may be captured for the target pixel block included in the current local area by using the foregoing set pixel window.

Specifically, the pixel window may be generally determined based on a preset pixel block size. The preset pixel block size may be a size of a single pixel block of the target video frame, or may be a size of a plurality of pixel blocks. This is not limited in this embodiment of this disclosure. For example, the size of the pixel block may be represented by w×h. In this case, the size of the pixel window may be represented by w×h, where w is used for representing a quantity of pixels corresponding to the width of the pixel block, and h is used for representing a quantity of pixels corresponding to the height of the pixel block.

It should be noted that for capturing of pixel block information of a target pixel block in a preset selected area, the target pixel block in the preset selected area refers to each pixel block included in the preset selected area. In this case, the target pixel block included in the single preset selected area may include a plurality of pixel blocks. A size of a pixel capturing window is determined based on a size of a single pixel block, a range size or the dimension of the preset selected area is determined based on a size of a coding unit used when the encoder performs coding, and the range size or the dimension of the preset selected area is greater than the size of the pixel capturing window. To ensure complete capturing of pixel block information of all pixel blocks included in the preset selected area, the pixel window may be moved in the preset selected area, and pixel block information of a target pixel block located in the pixel window is continuously captured based on the moved pixel window, until movement of the pixel window in the preset selected area is completed, and capturing of pixel block information of all target pixel blocks included in the preset selected area is completed.

Step 103: Construct a hash table of the preset selected area of the target video frame based on the pixel block information.

In an embodiment of this disclosure, after the pixel block information of the preset selected area in the large motion state is obtained, the hash table of the preset selected area of the target video frame may be constructed based on the pixel block information, to help provide a reference block index for a subsequent to-be-coded frame based on the constructed hash table, to search for an ideal reference block to perform motion estimation during coding on the to-be-coded block based on the reference block, thereby completing prediction and coding of the to-be-coded block.

The preset selected area in the large motion state in the SCC video usually has a feature of being a local area. In a process of constructing the hash table, a manner of selectively constructing a hash table based on the preset selected area is mainly used, to be specific, the hash table of the target video frame may be formed by hash tables of a plurality of preset selected areas of the target video frame. The hash tables used for forming the hash table of the target video frame include hash tables of preset selected areas in the large motion state. Because a preset selected area not in the large motion state can be well predicted and coded by using conventional modes such as Skip, Merge, Amvp, and Intra, the hash tables used for forming the hash table of the target video frame do not include hash tables of the preset selected areas not in the large motion state.

In an actual application, the process of constructing the hash table may be selectively constructing the table based on the preset selected area. After hash table construction is performed on a target pixel block included in a preset selected area in the large motion state, a range size or a dimension of a single preset selected area hardly covers the entire target video frame. To completely traverse and analyze all local areas included in the target video frame, a next local area in the target video frame may be analyzed in this case.

To be specific, according to a preset area range of a preset selected area, a next preset selected area may be continuously determined in the target video frame, motion vector information included in the next preset area range of the target video frame is obtained, pixel block information of one or more target pixel blocks in the next preset selected area of the target video frame is obtained based on the motion vector information and the preset motion vector threshold, and the hash table of the next preset selected area of the target video frame is constructed based on the pixel block information until the determined preset selected areas completely cover the target video frame. There is no pixel overlap between areas, that is, there are no same pixel blocks between areas, thereby avoiding analyzing same pixel blocks of the target video frame in the analysis process.

The pixel block information is pixel block information for the target pixel block, the target pixel block belongs to the target video frame, and the target video frame is a coded video frame. In this case, the target pixel block is a coded block included in the target video frame. When a hash table is constructed for a coded block, a coding feature value of a target pixel block at each location may be used as an index, and pixel block coordinate information of the target pixel block at each location may be used as content to which a corresponding index points, so that one index may point to a plurality of pieces of content, to construct the hash table. The content specifically refers to a location of a texture block in an image. Texture content at different locations may be consistent, to help provide a reference block index for coding a to-be-coded block subsequently.

It should be noted that, the hash table construction method provided based on this embodiment of this disclosure may be applied to an encoder for SCC video. The encoder may be an encoder developed and obtained based on the H.265/HEVC coding standard, and may perform video coding on an SCC video by using a constructed hash table.

In this embodiment of this disclosure, motion vector information included in a preset selected area of a target video frame is obtained, then pixel block information of one or more target pixel blocks in the preset selected area is obtained when the obtained motion vector information is greater than a preset motion vector threshold, and a hash table of the preset selected area is constructed. The motion vector information is introduced into a process of constructing the hash table, and the hash table is constructed for a preset selected area of a target video frame when the motion vector information is greater than a preset motion vector threshold, thereby implementing selective construction of the hash table in divided areas, shortening construction time of the hash table, and further reducing time complexity and coding complexity.

FIG. 2 is a flowchart illustrating steps of another hash table construction method according to an embodiment of this disclosure. The method may specifically include the following steps.

Step 201: In response to at least one piece of motion vector information being greater than the preset motion vector threshold, capture, by using the pixel window, the pixel block information of the one or more target pixel blocks in the preset selected area of the target video frame.

In this embodiment of this disclosure, the hash table may be selectively constructed based on estimation of a video motion. Specifically, by introducing motion vector information, status determining of a preset selected area in a target video frame is performed based on a preset motion vector threshold, to selectively construct the hash table for a preset selected area in a large motion state, and a frame-level pixel-by-pixel table construction manner based on an entire frame in HashMe is replaced with an area-level table construction manner for an area in the large motion state, so that the complexity of HashMe is reduced, and compression efficiency gains brought by HashMe are not affected.

Specifically, a large motion usually occurs in a local area and has very short duration, and a hash table construction manner based on an area may be performed on the target video frame.

The manner of constructing the hash table based on an area may be represented as selectively constructing the hash table. Specifically, the hash table may be selectively constructed based on video motion estimation. Specifically, selectively constructing the hash table may be represented as follows: motion vector information is introduced, status of a preset selected area in the target video frame is determined based on a preset motion vector threshold, a hash table is selectively constructed for the preset selected area in a large motion state.

The large motion state may be a state in which an object moves rapidly, and may be specifically determined based on the motion vector information. The motion vector information may be used for representing a current motion vector direction and a motion distance. Generally, when the motion distance in the current motion vector direction is greater than a set motion distance threshold in the current motion vector direction, it may be considered that the situation satisfies a condition of being in the large motion state.

In an actual application, the motion vector information included in the preset selected area of the target video frame may usually include a plurality of pieces of motion vector information.

In an embodiment of this disclosure, a single preset selected area may include a plurality of pieces of motion vector information. When at least one piece of motion vector information is greater than the preset motion vector threshold, the pixel block information of the one or more target pixel blocks in the preset selected area of the target video frame may be captured by using the pixel window.

Specifically, the motion vector information may include first dimension motion vector information and second dimension motion vector information, and the preset motion vector threshold may include a preset first dimension motion vector threshold and a preset second dimension motion vector threshold. In this case, in response to first dimension motion vector information of at least one piece of motion vector information being greater than the preset first dimension motion vector threshold, or second dimension motion vector information of at least one piece of motion vector information being greater than the preset second dimension motion vector threshold, it may be determined that the video frame has a large motion within a range of the preset selected area, that is, a local area corresponding to the preset selected area is in the large motion state. In this case, the pixel block information of the one or more target pixel blocks in the preset selected area of the target video frame may be captured by using the pixel window.

For example, the motion vector information may be MV information. The MV information is a two dimensional vector, and may be written in a mathematical expression form of (x, y), where x is a coordinate in a horizontal direction, and y is a coordinate in a vertical direction. In this case, (x, y) may be used in the MV information to represent a current MV direction and a motion distance. A threshold for measuring an MV motion magnitude, namely, the preset motion vector threshold, may also be a two dimensional vector, and may be expressed by using (x, y). First dimension motion vector information included in the MV information may be represented by mv. x, where mv. x represents a current motion distance in the x direction, and second dimension motion vector information included in the MV information may be represented by mv. y, where mv. y represents a current motion distance in the y direction. The preset first dimension motion vector threshold may be represented by x_thr, where x_thr represents a motion distance threshold in the x direction, and the preset second dimension motion vector threshold may be represented by y_thr, where y_thr represents a motion distance threshold in the y direction.

When the MV information included in the preset selected area is analyzed, assuming that there are a plurality of pieces of MV information, one piece of MV information in the plurality of pieces of MV information satisfies mv.x>x_thr, or one piece of MV information in the plurality of pieces of MV information satisfies mv.y>y_thr, it indicates that a motion distance of the current MV in at least one of the x and y directions is large, and the current MV is referred to as large motion. It may be considered that the current preset selected area is in the large motion state, and is a large motion area. The large motion area is presented in the video that an object in this area moves rapidly, and a texture area in which an object moves rapidly exists in the large motion area. For the texture area in which an object moves rapidly, a conventional inter-frame prediction technology is limited by complexity, and it is difficult to match an ideal reference block. In this case, it is easy to find an ideal reference block by using a hash table to index the reference block, thereby improving compression efficiency in the video coding process.

In an embodiment of this disclosure, after it is determined that the current preset selected area is the large motion area, the pixel block information of the one or more target pixel blocks in the preset selected area of the target video frame may be captured by using the pixel window, to construct the hash table.

The pixel block information of the target pixel block may be captured based on the pixel window. The pixel window may be generally determined based on a preset pixel block size. The preset pixel block size may be a size of a single pixel block of the target video frame, or may be a size of a plurality of pixel blocks. This is not limited in this embodiment of this disclosure. For example, the size of the pixel block may be represented by w×h. In this case, the size of the pixel window may be represented by w×h, where w is used for representing a quantity of pixels corresponding to the width of the pixel block, and h is used for representing a quantity of pixels corresponding to the height of the pixel block.

For capturing of pixel block information of a target pixel block in a preset selected area, the target pixel block in the preset selected area refers to each pixel block included in the preset selected area. In this case, the target pixel block included in the single preset selected area may include a plurality of pixel blocks. A size of a pixel capturing window is determined based on a size of a single pixel block, a range size or the dimension of the preset selected area is determined based on a size of a coding unit used when the encoder performs coding, and the range size or the dimension of the preset selected area is greater than the size of the pixel capturing window. To ensure complete capturing of pixel block information of all pixel blocks included in the preset selected area, the pixel window may be moved in the preset selected area, and pixel block information of a target pixel block located in the pixel window is continuously captured based on the moved pixel window, until movement of the pixel window in the preset selected area is completed, and capturing of pixel block information of all target pixel blocks included in the preset selected area in the large motion state is completed.

Specifically, a pixel block in the pixel window of the target video frame may be determined as the target pixel block, and the pixel block information of the target pixel block is captured; and then the pixel window may be continuously slid within a preset area range of the target video frame according to a preset horizontal step and a preset vertical step, a pixel block in the pixel window of the target video frame is continuously determined as the target pixel block, and the pixel block information of the target pixel block is captured, until pixel block information of all target pixel blocks included in the preset selected area of the target video frame are captured. In an actual application, the moving the pixel window in the preset selected area may be specifically represented as traversing pixels included in the preset selected area based on an upper left pixel point of the pixel window.

For example, for a preset selected area, a w×h pixel window may be used to slide on the current preset selected area according to a preset horizontal step sh and a preset vertical step sv. Pixel block information of pixel blocks at all locations in the current preset selected area is collected, and is gradually added to the hash table of the target video frame until the current preset selected area is traversed completely.

In some embodiments of this disclosure, when the MV information included in the preset selected area is analyzed, generally, there are a plurality of pieces of MV information, and no MV information in the plurality of pieces of MV information satisfies mv.x>x_thr or satisfies mv.y>y_thr, in other words, the MV information included in the current preset selected area does not satisfy the large motion state. In this case, an object, for example, a static background area photographed by a static camera, is in a nearly-static state in the video. Prediction and coding can be performed by using conventional inter-frame prediction technologies in this case. In other words, the preset selected area not in the large motion state can be well predicted and coded by using the conventional modes such as Skip, Merge, Amvp, and Intra, and there is no requirement for matching a reference block by using the hash method. An operation of constructing the hash table for the pixel blocks in the current preset selected area may not be performed, and the process of constructing the hash table is skipped, thereby improving the utilization of HashMe as much as possible.

Step 202: Construct a hash table of at least one preset selected area of the target video frame based on the pixel block information, and obtain the hash table of the target video frame based on the hash table of the at least one preset selected area.

In an embodiment of this disclosure, after the pixel block information of the preset selected area in the large motion state is obtained, the hash table of the preset selected area of the target video frame may be constructed based on the pixel block information, to help provide a reference block index for a subsequent to-be-coded frame based on the constructed hash table, to search for an ideal reference block to perform motion estimation during coding on the to-be-coded block based on the reference block, thereby completing prediction and coding of the to-be-coded block.

The preset selected area in the large motion state in the SCC video usually has a feature of being a local area. In a process of constructing the hash table, a manner of selectively constructing a hash table based on the preset selected area is mainly used, to be specific, the hash table of the target video frame may be formed by hash tables of a plurality of preset selected areas of the target video frame. The hash tables used for forming the hash table of the target video frame include hash tables of preset selected areas in the large motion state. Because a preset selected area not in the large motion state can be well predicted and coded by using conventional modes such as Skip, Merge, Amvp, and Intra, the hash tables used for forming the hash table of the target video frame do not include hash tables of the preset selected areas not in the large motion state.

In an actual application, the process of constructing the hash table may be selectively constructing the table based on the preset selected area. After hash table construction is performed on a target pixel block included in a preset selected area in the large motion state, a range size or a dimension of a single preset selected area hardly covers the entire target video frame. To completely traverse and analyze all local areas included in the target video frame, a next local area in the target video frame may be analyzed in this case.

To be specific, according to a preset area range of a preset selected area, a next preset selected area may be continuously determined in the target video frame, motion vector information included in the next preset area range of the target video frame is obtained, pixel block information of one or more target pixel blocks in the preset selected area of the next target video frame is obtained based on the motion vector information and the preset motion vector threshold, and the hash table of the next preset selected area of the target video frame is constructed based on the pixel block information until the determined preset selected areas completely cover the target video frame. There is no pixel overlap between areas, that is, there are no same pixel blocks between areas, thereby avoiding analyzing same pixel blocks of the target video frame in the analysis process.

The pixel block information is pixel block information for the target pixel block, the target pixel block belongs to the target video frame, and the target video frame is a coded video frame. In this case, the target pixel block is a coded block included in the target video frame.

The target pixel block may include at least one target pixel block at different locations. The pixel block information may include a coding feature value and pixel block coordinate information. When hash table construction is performed on a coded block, a coding feature value of the at least one target pixel block may be extracted, and pixel block coordinate information of the at least one target pixel block is obtained. The coding feature value of the target pixel block at each location is used as an index, and the pixel block coordinate information of the target pixel block at each location is used as content to which the corresponding index points. The pixel block coordinate information of each target pixel block may be coordinates (x, y) of an upper left pixel point of the pixel block. The content is specifically a location of a texture block in the image. Texture content at different locations may be the same, so that one index may point to a plurality of pieces of content. A hash table of the preset selected area of the target video frame is constructed, to be used to help provide a reference block index for coding a to-be-coded block subsequently.

In a specific implementation, the coding feature value refers to a numerical value that can represent a texture block with the highest possible specificity. A manner for generating such feature values may include, for example, generating a feature value based on pixels and/or gradient of individual pixel blocks. However, a feature value generated in this manner has low specificity, that is, a phenomenon that feature values generated for content of a plurality of different textures are the same will occur. Consequently, this causes a situation in which similarity degrees between two pixel blocks cannot be determined efficiently by comparing feature values of the two pixel blocks. In another example, a manner for generating a feature value, such as a CRC cyclic redundancy check code, may be included. This manner has highly specificity, but has a disadvantage that it can match two same pixel blocks, but cannot match two pixel blocks that are not completely the same but are highly similar. It should be noted that a specific generation manner of a feature value is not limited herein in this embodiment of this disclosure.

Step 203: In response to the target video frame being a scene switching frame reference frame, capture, by using a pixel window, pixel block information of one or more pixel blocks included in the scene switching frame reference frame, and construct a hash table of the scene switching frame reference frame based on the pixel block information of the one or more pixel blocks included in the scene switching frame reference frame.

In some embodiments of this disclosure, when the target video frame is a scene switching frame reference frame, it is represented as a phenomena similar to PPT page turning and Word document moving up quickly. In this case, a reference block thereof will be changed significantly. In this case, a conventional inter-frame prediction technology is difficult for most to-be-coded blocks to match an ideal reference block within a complexity limit. Frame-level table construction may be additionally performed for the reference block, so that the frame-level pixel-by-pixel table construction manner based on an entire frame and the area-level table construction manner for an area in a large motion state are combined, to improve utilization of HashMe as much as possible, and reduce complexity of HashMe as much as possible while ensuring performance gains.

It should be noted that, the additional frame-level table construction of a reference frame can help the coding of most blocks. Because scene switching is usually not frequent in a video, the frame-level pixel-by-pixel table construction manner based on an entire frame does not increase excessive complexity.

In an actual application, it may be determined whether the current target video frame hits scene switching, in response to the target video frame being a scene switching frame reference frame, pixel block information of one or more pixel blocks included in the scene switching frame reference frame may be captured by using a pixel window, and then a hash table of the scene switching frame is constructed based on the pixel block information of the one or more pixel blocks included in the scene switching frame reference frame.

A manner of determining whether the target video frame hits scene switching may be represented as determining based on output information of a video coding pre-analysis module. The video coding pre-analysis module and a video core coding module may be modules included in an encoder. A process implemented by the video coding pre-analysis module may be before an implementation process of the video core coding module. A function of the video coding pre-analysis module may be represented as outputting information such as a frame-level quantization parameter and a frame type of a current frame by analyzing video frames, and providing the information to the core coding module.

During specific implementation, the video coding pre-analysis module may generate information such as a rough MV and intra/inter-frame prediction costs in an analysis process. The information may be used for determining whether the current target video frame is the scene switching frame reference frame. For example, when inter-frame prediction costs are close to or even higher than intra-frame prediction costs, it may indicate that there is a large probability that the current target video frame is the scene switching frame reference frame.

In the process of capturing, by using the pixel window, the pixel block information of the one or more pixel blocks included in the scene switching frame reference frame, the pixel window may be generally determined based on a preset pixel block size. The preset pixel block size may be a size of a single pixel block of the target video frame, or may be a size of a plurality of pixel blocks. This is not limited in this embodiment of this disclosure. For example, the size of the pixel block may be represented by w×h. In this case, the size of the pixel window may be represented by w×h, where w is used for representing a quantity of pixels corresponding to the width of the pixel block, and h is used for representing a quantity of pixels corresponding to the height of the pixel block.

The pixel block information is pixel block information for the target pixel block, the target pixel block belongs to the target video frame, and the target video frame is a coded video frame. In this case, the target pixel block is a coded block included in the target video frame. When a hash table is constructed for a coded block, a coding feature value of a target pixel block at each location may be used as an index, and pixel block coordinate information of the target pixel block at each location may be used as content to which a corresponding index points, so that one index may point to a plurality of pieces of content, to construct the hash table. The content specifically refers to a location of a texture block in an image. Texture content at different locations may be consistent, to help provide a reference block index for subsequently coding a to-be-coded block referencing the scene switching frame reference frame.

Specifically, it is assumed that the pixel window is determined based on the size of a single pixel block of the target video frame. In a process of capturing pixel block information of the entire target video frame by using the pixel window, it is difficult for the single pixel window to cover the entire target video frame. To completely capture pixel block information of target pixel blocks included in the target video frame, the pixel window may be moved on the entire target video frame, and pixel block information of a target pixel block located in the pixel window is continuously captured based on the moved pixel window, until capturing of pixel block information of all target pixel blocks included in the entire target video frame is completed.

The frame-level table construction manner is represented as that table construction is performed on a dimension of a frame. For example, for the construction of the hash table of w×h blocks, there will be a w×h pixel window. In this case, the pixel window may slide on the target video frame according to a preset horizontal step sh and a preset vertical step sv. Pixel block information of pixel blocks at all locations in the target video frame is captured, and is gradually added to a hash table of the target video frame, that is, a hash table of the scene switching frame reference frame, until the scene switching frame reference frame is traversed completely. It should be noted that, smaller values of the preset horizontal step sh and the preset vertical step sv indicates a larger quantity of candidate blocks for constructing the table, and a larger help to performance of HashMe. Generally, sh=1 and sv=1 may be set, and this is not limited in this disclosure.

In an embodiment of this disclosure, when hash table construction is performed on a coded block, a coding feature value of the at least one target pixel block may be extracted, and pixel block coordinate information of the at least one target pixel block is obtained. The coding feature value of the target pixel block at each location is used as an index, and the pixel block coordinate information of the target pixel block at each location is used as content to which the corresponding index points. The pixel block coordinate information of each target pixel block may be coordinates (x, y) of an upper left pixel point of the pixel block. The content is specifically a location of a texture block in the image. Texture content at different locations may be the same, so that one index may point to a plurality of pieces of content. A hash table of the scene switching frame reference frame is constructed, to be used to help provide a reference block index for subsequently coding a to-be-coded block referencing the scene switching frame reference frame.

In this embodiment of this disclosure, the frame-level pixel-by-pixel table construction manner based on an entire frame and the area-level table construction manner for an area in a large motion state are combined, to improve utilization of HashMe as much as possible, and reduce complexity of HashMe as much as possible while ensuring performance gains.

It should be noted that, a process of combining the frame-level pixel-by-pixel table construction manner based on an entire frame and the area-level table construction manner for an area in a large motion state may be specifically represented as constructing a hash table of a target video frame according to the area-level table construction manner, and then when it is determined that the current target video frame is a scene switching frame reference frame, frame-level table construction is supplemented for the reference frame, in other words, the foregoing area-level table construction has been performed on the reference frame for which the frame-level table construction needs to be supplemented.

Step 204: Code the to-be-coded video frame by using the constructed hash table.

It should be noted that the hash table may be constructed while the target video frame is being coded. A hash table used during coding of the target video frame is a hash table of the reference frame of the target video frame. The hash table constructed for the target video frame is mainly used for a subsequent frame referencing the target video frame. The frame referencing the target video frame may be a to-be-coded video frame. When the hash table constructed for the target video frame is used, the to-be-coded video frame may be obtained.

The constructed hash table may be a hash table constructed only in the frame-level pixel-by-pixel table construction manner based on an entire frame, or may be a hash table constructed by combining the frame-level pixel-by-pixel table construction manner based on an entire frame and the area-level table construction manner for an area in a large motion state. In this case, the constructed hash table may be used to code the to-be-coded video frame referencing the target video frame.

The to-be-coded video frame may include a to-be-coded block. During coding of the to-be-coded video frame, motion estimation may be performed on the to-be-coded block based on the reference block. In one case, the to-be-coded video frame may be coded by using a hash table of a preset selected area of the target video frame. In another case, the to-be-coded video frame may be coded by using the hash table of the preset selected area of the target video frame and a hash table of a scene switching frame reference frame.

Specifically, in a process of coding by using the hash table, prediction and coding may be specifically performed on a block at the same position in a next frame based on the constructed hash table. In other words, for the current to-be-coded block, a reference block of the current to-be-coded block may be determined based on an index of the hash table, so that motion estimation is performed on the to-be-coded block based on the determined reference block, thereby implementing prediction and coding of the current to-be-coded block. The motion estimation is specifically represented as estimating a pixel difference between a to-be-coded block and a reference block of the to-be-coded block. For example, content indexed by using a feature value is a candidate reference block, and then a reference block having a small pixel difference from the to-be-coded block is determined as an ideal reference block in a plurality of candidate reference blocks.

In this embodiment of this disclosure, motion vector information included in a preset selected area of a target video frame is obtained, then pixel block information of one or more target pixel blocks in the preset selected area is obtained when the obtained motion vector information is greater than a preset motion vector threshold, and a hash table of the preset selected area is constructed. The motion vector information is introduced into a process of constructing the hash table, and the hash table is constructed for a preset selected area of a target video frame when the motion vector information is greater than a preset motion vector threshold, thereby implementing selective construction of the hash table in divided areas, shortening construction time of the hash table, and further reducing time complexity and coding complexity.

FIG. 3 is a flowchart illustrating steps of another video coding method according to an embodiment of this disclosure. The method may specifically include the following steps.

Step 301: Obtain a to-be-coded video frame and a hash table of a target video frame of a video file in response to an input instruction of the video file.

The hash table construction method provided based on this embodiment of this disclosure may be applied to an encoder for SCC video. The encoder may be an encoder developed and obtained based on the H.265/HEVC coding standard, and may perform video coding on an SCC video by using a constructed hash table.

It should be noted that the hash table may be constructed while the target video frame is being coded. A hash table used during coding of the target video frame is a hash table of the reference frame of the target video frame. The hash table constructed for the target video frame is mainly used for a subsequent frame referencing the target video frame. The frame referencing the target video frame may be a to-be-coded video frame.

In an actual application, the obtained video file may be a to-be-coded SCC video. Specifically, an encoder using the H.265/HEVC coding standard may be used to perform video coding on the SCC video in response to the input instruction of the video file. Specifically, a to-be-coded video frame of the SCC video may be obtained. The to-be-coded video frame includes a current to-be-coded block. In this case, a reference block for performing motion estimation on the current to-be-coded block may be obtained. Specifically, the hash table of the target video frame may be obtained, to determine the reference block based on the hash table of the target video frame.

In this embodiment of this disclosure, the target video frame is a coded video frame that can be used for motion estimation.

The obtained hash table of the target video frame may include a hash table of a preset selected area of the target video frame. The hash table of the preset selected area may be constructed based on the pixel block information of the one or more target pixel blocks in the preset selected area of the target video frame according to motion vector information and a preset motion vector threshold.

The obtained hash table of the target video frame may further include a hash table of a scene switching frame reference frame, and the hash table of the scene switching frame reference frame may be constructed based on pixel block information of one or more pixel blocks included in the scene switching frame reference frame.

For a specific process of constructing the hash table of the target video frame, refer to content of the foregoing hash table construction method recorded in the foregoing embodiments of this disclosure, and details are not described herein again.

Step 302: Code the to-be-coded video frame by using the hash table of the target video frame.

In a process of coding by using the hash table, prediction and coding may be specifically performed on a block at the same position in a next frame based on the constructed hash table. In other words, for the to-be-coded block, a reference block of the current to-be-coded block may be determined based on an index of the hash table, thereby implementing prediction and coding of the current to-be-coded block.

The motion estimation is specifically represented as estimating a pixel difference between a to-be-coded block and a reference block of the to-be-coded block. For example, content indexed by using a feature value is a candidate reference block, and then a reference block having a small pixel difference from the to-be-coded block is determined as an ideal reference block in a plurality of candidate reference blocks.

It should be noted that, for a preset selected area not in the large motion state in the target video frame, a common video coding mode can be used to well predict and code a block at the same position in a next frame, and hash table construction does not need to be performed for pixel blocks in this type of preset selected area. Therefore, for a pixel block for which hash table construction is not performed, a conventional video coding technology may be used to implement subsequently prediction and coding of a block at the same position in the next frame by using the pixel block. In other words, there may further be a coding manner in which video coding is implemented by using the conventional video coding technology in combination with the hash tables constructed based on the frame-level table construction manner and the area-level table construction manner. A specific combined use manner of video coding is not limited in this embodiment of this disclosure.

In some embodiments of this disclosure, an encoder may be further provided, the encoder includes a computer program executed in the encoder, and the computer program, when executed by the encoder, implements any one of the hash table construction methods or any one of the video coding methods in the foregoing embodiments.

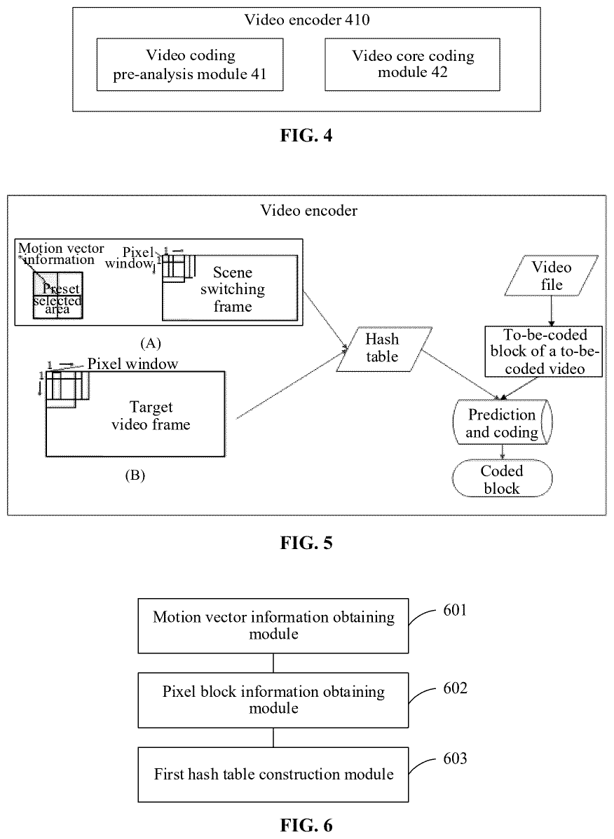

Specifically, FIG. 4 is a schematic diagram of a framework of a video encoder according to an embodiment of this disclosure. The video encoder 410 may relate to a video coding pre-analysis module 41 and a video core coding module 42. The video encoder 410 is an encoder using the H.265/HEVC coding standard, and can implement coding and compression operations for an SCC video. A process implemented by the video coding pre-analysis module 41 may be before a process implemented by the video core coding module 42. A function of the video coding pre-analysis module 41 may be represented as outputting information such as a frame-level quantization parameter and a frame type of a current frame by analyzing video frames, and providing the information to the video core coding module 42. The video core coding module 42 may be configured to construct a hash table and implement video coding, that is, use the constructed hash table.

In this embodiment of this disclosure, the hash table may be selectively constructed based on estimation of a video motion. Specifically, by introducing motion vector information, status determining of a preset selected area in a target video frame is performed based on a preset motion vector threshold, to selectively construct the hash table for a preset selected area in a large motion state, and a frame-level pixel-by-pixel table construction manner based on an entire frame in HashMe is replaced with an area-level table construction manner for an area in the large motion state, so that the complexity of HashMe is reduced, and compression efficiency gains brought by HashMe are not affected. In addition, when a target video frame hits scene switching, that is, the target video frame is a scene switching frame reference frame, frame-level table construction may be additionally performed on the target video frame. By combining the frame-level pixel-by-pixel table construction manner based on an entire frame and an area-level table construction manner for an area in a large motion state, utilization of HashMe is improved as much as possible, and complexity of HashMe is reduced as much as possible while a performance gain is ensured.

FIG. 5 is a schematic diagram of an application scenario of hash table construction and video coding according to an embodiment of this disclosure. In a related coding technology in which the video encoder shown in FIG. 4 is used for the SCC video, using HashMe as an example, HashMe is one of high efficiency coding tools for the SCC video, and is mainly represented as that: an encoder extracts a feature of a coded block during coding, then uses the feature as a subscript index of a hash table, and uses coordinates of the coded block as content pointed to by the index, so that one index may point to multiple content, thereby constructing the hash table. During motion searching, the encoder calculates a feature of a current to-be-coded block, finds a coded block having a feature value that is the same as a feature value of the current to-be-coded block mainly based on an index of a hash table of a reference frame of the current to-be-coded block, and uses the coded block as a reference block of the current to-be-coded block.

Specifically, an actual application of coding performed by the video encoder shown in FIG. 4 relates to a process of constructing the hash table and a process of using the hash table.

In the process of constructing the hash table, the hash table may be selectively constructed for a preset selected area in the large motion state, and frame-level table construction may be additionally performed on the target video frame when the target video frame hits scene switching, or in other words, the target video frame is a scene switching frame reference frame. The frame-level table construction manner is performed on a dimension of one frame, and the area-level table construction manner has a smaller dimension compared with the frame-level table construction manner.

In an actual application, when a hash table is selectively constructed for a preset selected area in a large motion state, as shown in (A) in FIG. 5, motion vector information included in the preset selected area of the target video frame may be obtained. A range size or a dimension of the preset selected area is generally less than a set size threshold of a coding unit, and is assumed to be 32×32. In this case, motion vector information included in a preset selected area whose range size is 32×32 at a location in the target video frame may be obtained. The obtained motion vector information, i.e. MV information, may include mv.x representing a current motion distance in an x direction and mv.y representing a current motion distance in ay direction. It is assumed that a threshold x_thr of a motion distance in the x direction is 100, and a threshold y_thr of a motion distance in the y direction is 100. If one piece of MV information in a plurality of pieces of MV information satisfies mv.x>x_thr, or one piece of MV information in a plurality of pieces of MV information satisfies mv.y>y_thr, it can be determined that the preset selected area whose size is 32×32 at the current location in the target video frame is in the large motion state, and belongs to a large motion area. In this case, pixel block information of the one or more target pixel blocks in the 32×32 preset selected area may be captured by using a pixel window.

Specifically, the size of the pixel block may be represented by w×h. In this case, the size of the pixel window may be represented by w×h, where w is used for representing a quantity of pixels corresponding to the width of the pixel block, and h is used for representing a quantity of pixels corresponding to the height of the pixel block. Assuming that w is 8 and h is 8, in this case, an 8×8 pixel window may be used to capture pixel block information of a target pixel block included in the current 8×8 pixel window in a preset selected area of 32×32.

Because a range size of the 32×32 preset selected area is greater than a size of the 8×8 pixel window, to ensure complete capturing of pixel block information of all pixel blocks included in the preset selected area, the 8×8 pixel window may be slid in the 32×32 preset selected area according to a preset horizontal step sh=1 and a preset vertical step sv=1, until target pixel blocks at all locations included in the 32×32 preset selected area are completely covered through sliding, and capturing of pixel block information on the target pixel blocks at all locations is completed.

In some embodiments of this disclosure, when the target video frame is a scene switching frame reference frame, it is represented as a phenomena similar to PPT page turning and Word document moving up quickly. In this case, a reference block thereof will be changed significantly. In this case, a conventional inter-frame prediction technology is difficult for most code blocks to match an ideal reference block within a complexity limit. Frame-level table construction may be additionally performed for the reference block. As shown in (B) in FIG. 5, the process of frame-level table construction may be represented as capturing, by using the 8×8 pixel window, pixel block information of a target pixel block included in the current 8×8 pixel window in the current target video frame, and the 8×8 pixel window may be slid in the target video frame according to the preset horizontal step sh=1 and the preset vertical step sv=1, until target pixel blocks at all locations included in the target video frame are completely covered through sliding, and capturing of pixel block information on the target pixel blocks at all locations is completed.

A manner for capturing the pixel block information may be represented as a cyclic redundancy check code generation manner. This is not limited in this embodiment of this disclosure.

The pixel block information may include a coding feature value and pixel block coordinate information. In this case, all target pixel blocks may be traversed, feature values of the target pixel blocks are calculated, then for each target pixel block, a memory space to which a corresponding address points is found, and pixel block coordinate information of the target pixel block is stored in the memory space. After storage of all the target pixel blocks is completed gradually, feature values of all the target pixel blocks and the memory space to which the feature values point may be referred to as a hash table, to complete construction of the hash table. The hash table may be constructed by using an array. The feature value may be considered as an address that points to a start location of a continuous memory space. The continuous memory space stores coordinates (x, y) of a pixel block whose feature value is a feature value corresponding to the address, so that one index may point to a plurality of pieces of content, and this helps provide a reference block index for coding a to-be-coded block subsequently.

In a process of using the hash table, when an ideal reference block is searched for a to-be-coded block, a feature value of a current to-be-coded block is calculated, and then a memory space corresponding to the feature value is found by using the hash table. If there are pixel block coordinates, each pixel block is used as a reference block for motion estimation. Specifically, a reference block may be determined based on an index of the hash table, to perform motion estimation on the to-be-coded block based on the determined reference block, thereby implementing prediction and coding on the to-be-coded block. The motion estimation is specifically represented as estimating a pixel difference between a code block and a reference block of the code block. For example, content indexed by using a feature value is a candidate reference block, and then a reference block having a small pixel difference from the to-be-coded block is determined as an ideal reference block in a plurality of candidate reference blocks.

It should be noted that, the motion vector information may be generated in an original procedure of performing video coding on the target video frame. In this case, the motion vector information included in the preset selected area may be obtained based on a position and a range size of the preset selected area in the target video frame. The original procedure of performing video coding on the target video frame is not limited in this embodiment of this disclosure.

In a preferred embodiment, after a lookahead window is set, motion vector information actually coded may further be replaced with motion vector information found by a preprocessing and analysis module of the encoder. The lookahead window may be set in coding parameter configurations, and a size of the lookahead window affects a video delay. Generally, there are different setting ranges in different video scenarios such as video on demand, live streaming, and RTC, for example, the size of the lookahead window may be set to 5. The preprocessing and analysis module pre-analyzes a current frame and four frames after the current frame, and starts to code the first frame after the analysis is completed. After the lookahead window is set, motion statuses of following frames can be known in advance based on the set lookahead window, and these motion statuses may replace original motion vector information in the area-level table construction manner to continue to select an area for table construction. This is not limited in this embodiment of this disclosure.

In this embodiment of the present disclosure, the hash table is selectively constructed based on estimation of a video motion. Specifically, by introducing motion vector information, status determining of a preset selected area in a target video frame is performed based on a preset motion vector threshold, to selectively construct the hash table for a preset selected area in a large motion state, and a frame-level pixel-by-pixel table construction manner based on an entire frame in HashMe is replaced with an area-level table construction manner for an area in the large motion state, so that the complexity of HashMe is reduced, and compression efficiency gains brought by HashMe are not affected. In addition, when a target video frame hits scene switching, that is, the target video frame is a scene switching frame reference frame, frame-level table construction may be additionally performed on the target video frame. By combining the frame-level pixel-by-pixel table construction manner based on an entire frame and an area-level table construction manner for an area in a large motion state, utilization of HashMe is improved as much as possible, and complexity of HashMe is reduced as much as possible while a performance gain is ensured.

It should be noted that, for simplicity of description, the method embodiments are expressed as a series of action combinations, but persons skilled in the art should be aware that the embodiments of this disclosure are not limited by the described action sequence, because according to embodiments of this disclosure, certain steps may be performed in other sequences or simultaneously. Persons skilled in the art should also be aware that the embodiments described in the specification are preferred embodiments, and that the actions involved are not required for embodiments of this disclosure.

FIG. 6 is a structural block diagram of a hash table construction apparatus according to an embodiment of this disclosure. The apparatus may specifically include the following modules:
a motion vector information obtaining module 601, configured to: obtain a target video frame, and obtain motion vector information included in a preset selected area of the target video frame;
a pixel block information obtaining module 602, configured to: in response to the motion vector information being greater than a preset motion vector threshold, obtain pixel block information of one or more target pixel blocks in the preset selected area of the target video frame; and
a first hash table construction module 603, configured to construct a hash table of the preset selected area of the target video frame based on the pixel block information.

In an embodiment of this disclosure, the pixel block information obtaining module 602 may include the following sub-modules:
a pixel window obtaining sub-module, configured to obtain a pixel window, where the pixel window is determined based on a preset pixel block size; and
a pixel block information capturing sub-module, configured to: in response to the motion vector information being greater than the preset motion vector threshold, capture, by using the pixel window, the pixel block information of the one or more target pixel blocks in the preset selected area of the target video frame.

In an embodiment of this disclosure, a plurality of pieces of motion vector information are included in the preset selected area of the target video frame; and the pixel block information capturing sub-module may include the following unit:
a pixel block information capturing unit, configured to: in response to at least one piece of motion vector information being greater than the preset motion vector threshold, capture, by using the pixel window, the pixel block information of the one or more target pixel blocks in the preset selected area of the target video frame.

In an embodiment of this disclosure, the motion vector information includes first dimension motion vector information and second dimension motion vector information, and the preset motion vector threshold includes a preset first dimension motion vector threshold and a preset second dimension motion vector threshold.

The pixel block information capturing unit may include the following sub-unit:
a pixel block information capturing sub-unit, configured to: in response to the first dimension motion vector information of at least one piece of motion vector information being greater than the preset first dimension motion vector threshold, or the second dimension motion vector information of at least one piece of motion vector information being greater than the preset second dimension motion vector threshold, capture, by using the pixel window, the pixel block information of the one or more target pixel blocks in the preset selected area of the target video frame.

The capturing, by using the pixel window, the pixel block information of the one or more target pixel blocks in the preset selected area of the target video frame includes: determining a pixel block in the pixel window of the target video frame as the target pixel block, and capturing the pixel block information of the target pixel block; and continuously sliding the pixel window within a range of the preset selected area of the target video frame according to a preset horizontal step and a preset vertical step, continuously determining a pixel block in the pixel window of the target video frame as the target pixel block, and capturing the pixel block information of the target pixel block, until pixel block information of all target pixel blocks included in the preset selected area of the target video frame are captured.

In an embodiment of this disclosure, the first hash table construction module 603 is further configured to: continuously determine a next preset selected area in the target video frame according to a range size of the preset selected area, obtain motion vector information included in the next preset selected area of the target video frame, obtain pixel block information of one or more target pixel blocks in the next preset selected area based on the newly obtained motion vector information and the preset motion vector threshold, and construct a hash table of a next selected area of the target video frame based on newly obtained pixel block information until determined preset selected areas cover the target video frame.

In an embodiment of this disclosure, the target pixel block includes at least one target pixel block, and the pixel block information includes a coding feature value and pixel block coordinate information; and the first hash table construction module 603 may include the following sub-modules:
a coding feature value extraction sub-module, configured to: extract the coding feature value of the at least one target pixel block, and obtain pixel block coordinate information of the at least one target pixel block; and
a hash table construction sub-module, configured to construct the hash table of the preset selected area of the target video frame by using the coding feature value of each target pixel block as an index and the pixel block coordinate information of each target pixel block as content, where the hash table of at least one preset selected area of the target video frame forms a hash table of the target video frame.

In an embodiment of this disclosure, the hash table construction apparatus provided in this embodiment of this disclosure may further include the following module:
a second hash table construction module, configured to: in response to the target video frame being a scene switching frame reference frame, obtain a pixel window, capture, by using the pixel window, pixel block information of one or more pixel blocks included in the scene switching frame reference frame, and construct a hash table of the scene switching frame reference frame based on the pixel block information of the one or more pixel blocks included in the scene switching frame reference frame.

In an embodiment of this disclosure, the hash table construction apparatus provided in this embodiment of this disclosure may further include the following module:
a video coding module, configured to: obtain a to-be-coded video frame, and code the to-be-coded video frame by using the hash table of the preset selected area of the target video frame; and/or code the to-be-coded video frame by using the hash table of the preset selected area of the target video frame and the hash table of the scene switching frame, where the to-be-coded video frame is a video frame referring to the target video frame.

In this embodiment of this disclosure, based on the hash table construction apparatus provided in this embodiment of this disclosure, motion vector information included in a preset selected area of a target video frame is obtained, then pixel block information of one or more target pixel blocks in the preset selected area is obtained when the obtained motion vector information is greater than a preset motion vector threshold, and a hash table of the preset selected area is constructed. The motion vector information is introduced into a process of constructing the hash table, and the hash table is constructed for a preset selected area of a target video frame based on a fact that the motion vector information is greater than a preset motion vector threshold, thereby implementing selective construction of the hash table in divided areas, shortening construction time of the hash table, and further reducing time complexity and coding complexity.

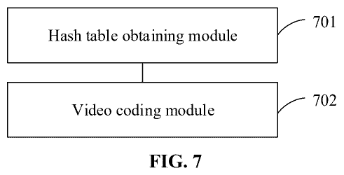

FIG. 7 is a structural block diagram of a video coding apparatus according to an embodiment of this disclosure. The apparatus may specifically include the following modules:
a hash table obtaining module 701, configured to obtain a to-be-coded video frame and a hash table of a target video frame of a video file in response to an input instruction of the video file, where the to-be-coded video frame is a video frame referring to the target video frame, the hash table of the target video frame includes a hash table of a preset selected area of the target video frame, and the hash table of the preset selected area is constructed based on pixel block information of one or more target pixel blocks in the preset selected area in response to motion vector information of the target video frame being greater than a preset motion vector threshold; and
a video coding module 702, configured to code the to-be-coded video frame by using the hash table of the target video frame.

In an embodiment of this disclosure, the hash table of the target video frame further includes a hash table of a scene switching frame reference frame, and the hash table of the scene switching frame reference frame is constructed based on pixel block information of one or more pixel blocks included in the scene switching frame reference frame.

In the embodiments of this disclosure, the video coding apparatus provided in the embodiments of this disclosure introduces the motion vector information into a process of constructing the hash table, and the hash table is constructed for a preset selected area of a target video frame when the motion vector information is greater than a preset motion vector threshold, thereby implementing selective construction of the hash table in divided areas, shortening construction time of the hash table, and further reducing time complexity and a coding complexity in the coding process.

Since the apparatus embodiment is substantially similar to the method embodiment, the description is relatively simple. For relevant parts, refer to the description of the method embodiment.

An embodiment of this disclosure further provides an electronic device.

The electronic device includes a processor, a memory, and a computer program stored on the memory and executable on the processor. The computer program, when executed by the processor, implements all processes of the foregoing hash table construction method or video coding method embodiments, and can achieve the same technical effects. To avoid repetition, details are not described herein again.

An embodiment of this disclosure further provides a computer-readable storage medium. The computer-readable storage medium stores a computer program, and the computer program, when executed by a processor, implements all processes of the foregoing hash table construction method or video coding method embodiments, and can achieve the same technical effects. To avoid repetition, details are not described herein again.

The embodiments in this specification are all described in a progressive manner. Descriptions of each embodiment focus on differences from other embodiments, and same or similar parts among respective embodiments may be mutually referenced.

Persons skilled in the art should understand that, the embodiments of this disclosure may be provided as methods, apparatuses, or computer program products. Therefore, the embodiments of this disclosure may use a form of hardware-only embodiments, software-only embodiments, or embodiments in which software and hardware are combined. Moreover, an embodiment of this disclosure may use a form of a computer program product that is implemented on one or more computer-usable storage media (including but not limited to a disk memory, a CD-ROM, an optical memory, and the like) that include computer-usable program code.

The embodiments of this disclosure are described with reference to the flowcharts and/or block diagrams of the method, the terminal device (system), and the computer program product according to the embodiments of this disclosure. It should be understood that computer program instructions may be used to implement each process and/or each block in the flowcharts and/or the block diagrams and a combination of processes and/or blocks in the flowcharts and/or the block diagrams. These computer program instructions may be provided for a general-purpose computer, a special-purpose computer, an embedded processor, or a processor of any other programmable data processing terminal device to generate a machine, so that the instructions executed by the computer or the processor of any other programmable data processing terminal device generate an apparatus for implementing a specific function in one or more procedures in the flowcharts and/or in one or more blocks in the block diagrams.

These computer program instructions may alternatively be stored in a computer-readable memory that can instruct a computer or other programmable data processing terminal devices to operate in a specific manner, so that the instructions stored in the computer-readable memory are used to produce a product including an instruction apparatus, and the instruction apparatus implements functions specified in one or more processes of the flowcharts and/or one or more blocks of the block diagrams.

These computer program instructions may also be loaded onto a computer or another programmable data processing terminal device, so that a series of operations and steps are performed on the computer or the another programmable terminal device, thereby generating computer-implemented processing. Therefore, the instructions executed on the computer or the another programmable terminal device provide steps for implementing a specific function in one or more processes in the flowcharts and/or in one or more blocks in the block diagrams.

Although exemplary embodiments of the embodiments of this disclosure have been described, persons skilled in the art can make other changes and modifications to these embodiments once they know the basic creative concept of this disclosure. Therefore, the following claims are intended to cover the exemplary embodiments and changes and modifications falling within the scope of the embodiments of this disclosure.

It should be noted that, user information (including but not limited to user equipment information, user personal information, and the like) and data (including but not limited to data for analysis, stored data, displayed data, and the like) in this disclosure are all information and data that are authorized by a user or that are fully authorized by all parties, and related data needs to be collected, used, and processed by complying with relevant laws, regulations, and standards of relevant countries and regions. In addition, a corresponding operation entry is provided for the user to select to authorize or reject.

It should be further noted that the relational terms herein such as first and second are used to differentiate an entity or operation from another entity or operation, and do not require or imply any actual relationship or sequence between these entities or operations. Moreover, the terms “include”, “comprise” or any other variants thereof are intended to cover non-exclusive inclusion, so that a process, method, article or terminal device including a series of elements not only includes those elements, but also includes other elements that are not explicitly listed, or also includes elements inherent to this process, method, article or terminal device. Without further limitation, the element defined by the sentence “including a . . . ” does not exclude that other identical elements are also present in the process, method, article or terminal device including the elements.

A hash table construction method, a video coding method, a corresponding encoder, a corresponding electronic device, and a corresponding computer-readable storage medium provided in this disclosure are described above in detail. Although the principles and implementations of the present disclosure are described by using specific examples in this specification, the descriptions of the foregoing embodiments are merely intended to help understand the method and the core idea of the method of the present disclosure. Meanwhile, persons of ordinary skill in the art may make modifications to the specific implementations and application range according to the idea of the present disclosure. In conclusion, the content of this specification is not construed as a limit on the present disclosure.

1. A hash table construction method, comprising:
obtaining a target video frame, and obtaining motion vector information comprised in a preset selected area of the target video frame;
in response to the motion vector information being greater than a preset motion vector threshold, obtaining pixel block information of one or more target pixel blocks in the preset selected area of the target video frame; and
constructing a hash table of the preset selected area of the target video frame based on the pixel block information.

2. The method according to claim 1, wherein the in response to the motion vector information being greater than a preset motion vector threshold, obtaining pixel block information of one or more target pixel blocks in the preset selected area of the target video frame comprises:
obtaining a pixel window, wherein the pixel window is determined based on a preset pixel block size; and
in response to the motion vector information being greater than the preset motion vector threshold, capturing, by using the pixel window, the pixel block information of the one or more target pixel blocks in the preset selected area of the target video frame.

3. The method according to claim 2, wherein a plurality of pieces of motion vector information are comprised in a preset selected area of the target video frame; and the in response to the motion vector information being greater than the preset motion vector threshold, capturing, by using the pixel window, the pixel block information of the one or more target pixel blocks in the preset selected area of the target video frame comprises:
in response to at least one piece of motion vector information being greater than the preset motion vector threshold, capturing, by using the pixel window, the pixel block information of the one or more target pixel blocks in the preset selected area of the target video frame.

4. The method according to claim 3, wherein the motion vector information comprises first dimension motion vector information and second dimension motion vector information, and the preset motion vector threshold comprises a preset first dimension motion vector threshold and a preset second dimension motion vector threshold; and
the in response to at least one piece of motion vector information being greater than the preset motion vector threshold, capturing, by using the pixel window, the pixel block information of the one or more target pixel blocks in the preset selected area of the target video frame comprises:
in response to the first dimension motion vector information of at least one piece of motion vector information being greater than the preset first dimension motion vector threshold, or the second dimension motion vector information of at least one piece of motion vector information being greater than the preset second dimension motion vector threshold, capturing, by using the pixel window, the pixel block information of the one or more target pixel blocks in the preset selected area of the target video frame.

5. The method according to claim 3, wherein the capturing, by using the pixel window, the pixel block information of the one or more target pixel blocks in the preset selected area of the target video frame comprises:
determining a pixel block in the pixel window of the target video frame as the target pixel block, and capturing the pixel block information of the target pixel block; and
continuously sliding the pixel window within a range of the preset selected area of the target video frame according to a preset horizontal step and a preset vertical step, continuously determining a pixel block in the pixel window of the target video frame as the target pixel block, and capturing the pixel block information of the target pixel block, until pixel block information of all target pixel blocks comprised in the preset selected area of the target video frame are captured.

6. The method according to claim 1, further comprising:
continuously determining a next preset selected area in the target video frame according to a range size of the preset selected area, obtaining motion vector information comprised in the next preset selected area of the target video frame, obtaining pixel block information of one or more target pixel blocks in the next preset selected area in response to newly obtained motion vector information being greater than the preset motion vector threshold, and constructing a hash table of the next preset selected area based on newly obtained pixel block information until determined preset selected areas cover the target video frame.

7. The method according to claim 1, wherein the preset selected area of the target video frame comprises at least one target pixel block, and the pixel block information comprises a coding feature value and pixel block coordinate information; and the constructing a hash table of the preset selected area of the target video frame based on the pixel block information comprises:
for each target pixel block, extracting the coding feature value of the target pixel block, and obtaining the pixel block coordinate information of the target pixel block; and
constructing the hash table of the preset selected area of the target video frame by using the coding feature value of each target pixel block as an index and the pixel block coordinate information of each target pixel block as content, wherein the hash table of at least one preset selected area of the target video frame forms a hash table of the target video frame.

8. The method according to claim 1, further comprising:
in response to the target video frame being a scene switching frame reference frame, obtaining a pixel window, capturing, by using the pixel window, pixel block information of one or more pixel blocks comprised in the scene switching frame reference frame, and constructing a hash table of the scene switching frame reference frame based on the pixel block information of the one or more pixel blocks comprised in the scene switching frame reference frame.

9. The method according to claim 8, further comprising:
obtaining a to-be-coded video frame, and coding the to-be-coded video frame by using the hash table of the preset selected area of the target video frame, wherein the to-be-coded video frame is a video frame referring to the target video frame; and/or
coding the to-be-coded video frame by using the hash table of the preset selected area of the target video frame and the hash table of the scene switching frame reference frame.

10. A video coding method, comprising:
obtaining a to-be-coded video frame and a hash table of a target video frame of a video file in response to an input instruction of the video file, wherein the to-be-coded video frame is a video frame referring to the target video frame, the hash table of the target video frame comprises a hash table of a preset selected area of the target video frame, and the hash table of the preset selected area is constructed based on pixel block information of one or more target pixel blocks in the preset selected area in response to motion vector information of the target video frame being greater than a preset motion vector threshold; and
coding the to-be-coded video frame by using the hash table of the target video frame.

11. The method according to claim 10, wherein the hash table of the target video frame further comprises a hash table of a scene switching frame reference frame, and the hash table of the scene switching frame reference frame is constructed based on pixel block information of one or more pixel blocks comprised in the scene switching frame reference frame.

12. An encoder, wherein the encoder comprises a computer program executed in the encoder, and the computer program, when executed by the operations comprising:
obtaining a target video frame, and obtaining motion vector information comprised in a preset selected area of the target video frame;
in response to the motion vector information being greater than a preset motion vector threshold, obtaining pixel block information of one or more target pixel blocks in the preset selected area of the target video frame; and
constructing a hash table of the preset selected area of the target video frame based on the pixel block information.

13. An electronic device, comprising: a processor, a memory, and a computer program stored on the memory and executable on the processor, wherein the computer program, when executed by the processor, implements the hash table construction method according to claim 1.

14. A non-transitory computer-readable storage medium, wherein the non-transitory computer-readable storage medium stores a computer program, and the computer program, when executed by a processor, implements the hash table construction method according to claim 1.

15. An encoder, wherein the encoder comprises a computer program executed in the encoder, and the computer program, when executed by the encoder, implements the video coding method according to claim 10.

16. An electronic device, comprising: a processor, a memory, and a computer program stored on the memory and executable on the processor, wherein the computer program, when executed by the processor, implements the video coding method according to claim 10.

17. A non-transitory computer-readable storage medium, wherein the non-transitory computer-readable storage medium stores a computer program, and the computer program, when executed by a processor, implements the video coding method according to claim 10.

18. The method according to claim 4, wherein the capturing, by using the pixel window, the pixel block information of the one or more target pixel blocks in the preset selected area of the target video frame comprises:
determining a pixel block in the pixel window of the target video frame as the target pixel block, and capturing the pixel block information of the target pixel block; and
continuously sliding the pixel window within a range of the preset selected area of the target video frame according to a preset horizontal step and a preset vertical step, continuously determining a pixel block in the pixel window of the target video frame as the target pixel block, and capturing the pixel block information of the target pixel block, until pixel block information of all target pixel blocks comprised in the preset selected area of the target video frame are captured.

19. The method according to claim 6, wherein the preset selected area of the target video frame comprises at least one target pixel block, and the pixel block information comprises a coding feature value and pixel block coordinate information; and the constructing a hash table of the preset selected area of the target video frame based on the pixel block information comprises:
for each target pixel block, extracting the coding feature value of the target pixel block, and obtaining the pixel block coordinate information of the target pixel block; and
constructing the hash table of the preset selected area of the target video frame by using the coding feature value of each target pixel block as an index and the pixel block coordinate information of each target pixel block as content, wherein the hash table of at least one preset selected area of the target video frame forms a hash table of the target video frame.

20. The method according to claim 6, further comprising:
in response to the target video frame being a scene switching frame reference frame, obtaining a pixel window, capturing, by using the pixel window, pixel block information of one or more pixel blocks comprised in the scene switching frame reference frame, and constructing a hash table of the scene switching frame reference frame based on the pixel block information of the one or more pixel blocks comprised in the scene switching frame reference frame.
